(19) United States
(12) Patent Application Publication
(10) Pub. No.: US 2007/0097832 A1
(43) Pub. Date: May 3, 2007

(54) Interoperation between virtual gaming environment and real-world environments

(75) Inventors: Elina M. Koivisto, Tampere (FI); Jouka Mattila, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/254,247

(22) Filed: Oct. 19, 2005

(51) Int. Cl. G11B 31/00

(52) U.S. Cl. 369/63

(57) ABSTRACT

A toy device is provided, which is interoperable with a virtual game application enabling a player for playing in a virtual gaming environment. The virtual game application comprises at least one game object controllable by the player. The game object has game specific characteristics, which are developable during playing. The toy device is provided to the player for playing in a real-world environment. The toy device represents a real-world analog of the game object and has one or more sensors, which are arranged to detect how a player a game plays of the player with the toy device. Sensor information is registered by the means of the one or more sensors. The sensor information is detected in consequence to how a game play of the player plays with the toy device in the real-world environment and is transferred to the game application to adjust the game specific characteristics of the game object in accordance with the game play in the real-world environment.

The present invention relates to wireless electronic gaming. In particular, the present invention relates to interoperation between virtual gaming environment and physical (real-world) gaming environment.

### BACKGROUND OF THE INVENTION

Portable consumer electronic devices especially in the form of mobile or cellular communication terminals (telephones) have become very popular and are in widespread use throughout the world. Moreover, the development in electronics and processor/micro-controller based technologies has resulted in a remarkable evolution of mobile communication terminals from portable analogs of traditional fixed-line telephones to multi-purpose processing terminals providing a large range of communication options including for instance wide area networking and local area networking as well as multi-faceted programmability including business suite applications (contact management, task management), communication applications (email application, chat application), video and photo applications, gaming applications and the like. The previously separate markets of personal digital assistant terminals (PDAs), mobile communication terminals, portable gaming consoles, and the like are converging into universal multi-purpose portable user terminals.

In particular, electronic games have become a significant economic market in the modem world which contributes significantly to the entertainment industry. The playing of electronic games on stand-alone terminals such as personal computers, dedicated gaming consoles, portable gaming consoles, and mobile communication terminals has long been popular. Therefore, it is for instance very common for portable communication terminals such as mobile communication terminals to have, preloaded on/in a memory of the terminal, content relating to one or more electronic games that can be played on the communication terminal through the terminal's User Interface (UI) usually involving a display and keys. Such (pre-) stored games may be accessed via navigation through the phone's various menu options for selection of the particular electronic game to be played. Certain keys of the mobile phone's keypad may be assigned control functionality for controlling certain predetermined features of the game in relation to other features of the game which may often be under the control of the software of the game. In this way, a user can play ‘against the computer.’

However, in recent years there are developments to migrate gaming into networked environments enabling interacting of several players in a gaming environment. Different variants of networked environments could be classified including for instance networked environments substantially employing wired networks including local area network (LAN), wide area network (WAN), Internet, Public Switched Telephone Network (PSTN) and the like for communications. With the developing extension of the Public Land Mobile Networks (PLMNs) especially in view of availability, data communication rates, user habituation, and expense, the mobile gaming environment will become a significant option in the networked gaming environment. Mobile gaming is a term used to refer to all aspects of electronic games in the context of portable terminals capable of wireless communications, especially mobile communications.

Networked gaming environments are distinguished in common by interactive multiplayer games, i.e., two or more players are involved in the same game and interact in a common gaming environment, which have also become available for use in mobile phone communication environments, with each player having a mobile phone in communication with one or more other mobile phones. In this way, the phones can communicate information about a game back and forth, each user or player using controls (e.g., assigned keys, buttons, joysticks or the like) on each of their respective phone units to control each of their particular game piece(s) or character(s) with which he/she plays against the other player(s), the phone units communicating respective player data entry, such as moves, to each of the other mobile phone units, thus constantly updating the state of the game for the benefit of all users/players. Examples of such multi-player, mobile gaming systems are described in the International Patent Application publication WO 2004 011114 and U.S. Pat. No. 6,579,184, inter alia.

Moreover, mobile telephone units have, in a discrete environment, also now been made useful as remote control units. As an example, there is available a Bluetooth controlled toy controllable by a mobile telephone unit. The International Patent Application, WO 1998 049818, describes a system enabling a mobile phone to provide combined mobile telephony and remote control terminal functionalities, particularly in one example, describing a mobile station (i.e., a mobile phone) which includes functionalities enabling the mobile station to communicate with a Public Land Mobile Network (PLMN) as well as providing command and communication (e.g., local communications) functionalities to remotely control one or more of a variety of peripheral devices through user provided inputs into the mobile phone.

However, traditional real world gaming and electronic gaming are substantially separate, i.e. interacting between both types of gaming is not enabled. An object of the present invention is to enable such an interacting between these two types of gaming such that gaming concepts of real world gaming and electronic gaming can be brought together in advantageous manners and ways, respectively.

### SUMMARY OF THE INVENTION

According to an aspect of the present invention, a method for using a toy device is provided. A game application is provided to a player for playing in a virtual gaming environment, which comprises at least one game object controllable by the player. The toy device is provided to the player for playing in a real-world environment. The toy device has one or more sensors, which are arranged to detect how a player plays with the toy device. Sensor information is registered by the means of the one or more sensors. The sensor information is detected in consequence to how the player plays with the toy device in the real-world environment. The sensor information is transferred to a state of the game in the virtual gaming environment in accordance with the play in the real-world environment. According to an embodiment of the present invention, the game object has game specific characteristics, which are developable during playing and the toy device represents a real-world analog of the game object. The sensor information is transferred to the game application to adjust the game specific characteristics of the game object in accordance with the playing in the real-world environment.

According to an embodiment of the present invention, the player is invited to perform at least a part of the game with the toy device in the real-world environment in order to progress in the game in the virtual gaming environment.

According to an embodiment of the present invention, the player can play in the real-world gaming environment at any time. The sensor information registered in consequence to the physical playing in the real-world environment is transferable to the game application at any time.

According to an embodiment of the present invention, the playing in the real-world gaming environment is operative within rules of the game. According to an embodiment of the present invention, the toy device represents a manifestation of the game object. However, the toy device is not essentially a form or shape-like representation. The toy device may represent a manifestation of the game object which is part of a complex or composed game object.

According to an embodiment of the present invention, an accessory to the toy device is provided. The accessory may be an accessory part, an extension part, and the like. The accessory improves toy specific characteristics of the toy device. The toy specific characteristics affect the playing with the toy device in the real-world environment. The characteristics of the toy device are transferred to the game application to adjust the game specific characteristics of the game object in accordance with the toy specific characteristics. According to an embodiment of the present invention, the toy device is user-constructable from a construction kid including basic interlocking elements. The toy specific characteristics of the toy device are based on the resulting user construction thereof. The characteristics of the toy device are transferred to the game application to adjust the game specific characteristics of the game object in accordance with the toy specific characteristics.

According to an embodiment of the present invention, the game specific characteristics resulting from the play in the virtual gaming environment are transferred to the toy device such that the toy specific characteristics are adjustable in accordance with the game specific characteristics.

According to an embodiment of the present invention, the toy device comprises a controlling logic, which is adapted to control a behavior of the toy device during playing in accordance with toy specific characteristics.

According to an embodiment of the present invention, the game application is hosted on a game server A client application is provided to access a game engine executed on the game server to play the game in the virtual gaming environment.

According to an embodiment of the present invention, the game server maintains at least game related data including the game specific characteristics of the game object.

According to an embodiment of the present invention, the toy device is remotely controlled by the means of a portable processing device acting as remote controller. In particular, the remote controller is a portable communication device provided with remote control software. According to an embodiment of the present invention, an interconnection is established between the toy device and the game application through a processing device, which is in particular a portable communication terminal.

According to an embodiment of the present invention, the toy device is operable by the means of a processing device detachably attached to the toy device. The processing device is in particular a portable communication device, which has preferably a cover including one or more projections or sockets cooperative with respective supports of the toy device.

According to an embodiment of the present invention, the sensor information is registered with the help of the processing device.

According to an embodiment of the present invention, the toy device comprises a data communication interface communicative with a processing device, which is in particular a portable communication device.

According to another aspect of the present invention, a toy device operative in a game is provided. The toy device comprises one or more sensors, which are arranged to detect how a player plays with the toy device and which are arranged for registering sensor information in consequence to how the player plays with the toy device in the real-world environment. A data interface is adapted to enable transfer of sensor information to a game application. The game application is provided to the player for playing in a virtual gaming environment, which comprises at least one game object controllable by the player. The toy device is provided to the player for playing in a real-world environment. The sensor information supplied to the game application enables to adjust a state of the game in the virtual gaming environment in accordance with the game play in the real-world environment.

According to an embodiment of the present invention, the game object has game specific characteristics, which are developable during playing and the toy device represents a real-world analog of the game object. The sensor information is transferred to the game application to adjust the game specific characteristics of the game object in accordance with the playing in the real-world environment.

According to an embodiment of the present invention, the player is invited to perform at least a part of the game with the toy device in the real-world environment in order to progress in the game in the virtual gaming environment.

According to an embodiment of the present invention, the player is enabled for playing in the real-world environment at any time. The sensor information registered in consequence to the playing in the real-world environment is transferable to the game application at any time.

According to an embodiment of the present invention, the playing in the real-world environment is operative within rules of the game.

According to an embodiment of the present invention, an accessory provided for the toy device. The accessory improves toy specific characteristics of the toy device. The toy specific characteristics affect the playing with the toy device in the real-world environment. The characteristics of the toy device are transferred to the game application to adjust the game specific characteristics of the game object in accordance with the toy specific characteristics.

According to an embodiment of the present invention, the toy device is user-constructable from a set of interlocking elements. The toy specific characteristics of the toy device are based on the resulting user construction thereof. The characteristics of the toy device are transferred to the game application to adjust the game specific characteristics of the game object in accordance with the toy specific characteristics.

According to an embodiment of the present invention, the game specific characteristics resulting from the playing in the virtual gaming environment are transferred to the toy device and the toy specific characteristics are adjusting in accordance with the game specific characteristics.

According to an embodiment of the present invention, the toy device comprises a controlling logic, which is adapted to control a behavior of the toy device, in particular a mechanical behavior, during playing in accordance with toy specific characteristics.

According to an embodiment of the present invention, the game application is hosted on a game server. A client application is provided to enable access to a game engine executed on the game server such that the virtual game can be played by the player.

According to an embodiment of the present invention, the game server maintains at least game related data including the game specific characteristics of the game object.

According to an embodiment of the present invention, the toy device is arranged for remote control by the means of a portable processing device, which is in particular a portable communication device provided with a remote control software executable thereon.

According to an embodiment of the present invention, a data interconnection is established between the toy device and the game application through a processing device, which is in particular a portable communication terminal.

According to an embodiment of the present invention, the toy device is operable by the means of a processing device detachably attached to the toy device. The processing device is in particular a portable communication device, which has preferably a cover including one or more projections or sockets cooperative with respective supports of the toy device.

According to an embodiment of the present invention, the sensor information is registered with the help of the processing device.

According to an embodiment of the present invention, the toy device comprises a data communication interface communicative with a processing device, which is in particular a portable communication device.

According to another aspect of the present invention, a processing device is provided, which is arranged for operative coupling with a toy device. The toy device comprises one or more sensors, which are arranged for detecting how a player plays with the toy device and registering sensor information in consequence to how the player plays with the toy device in the real-world environment. A data interface is arranged for communication with the toy device to transfer the sensor information to a game application. The game application is provided to the player for playing in a virtual gaming environment, which comprises at least one game object controllable by the player. The toy device is provided to the player for playing in a real-world environment. The sensor information supplied to the game application enables to adjust a state of the game in the virtual gaming environment in accordance with the game play in the real-world environment.

According to an embodiment of the present invention, the game object has game specific characteristics, which are developable during playing and the toy device represents a real-world analog of the game object. The sensor information is transferred to the game application to adjust the game specific characteristics of the game object in accordance with the playing in the real-world environment.

According to an embodiment of the present invention, the processing device is one out of a group comprising a portable communication terminal, a PC, and a notebook.

According to an embodiment of the present invention, the game application is operable with the processing device.

According to an embodiment of the present invention, a client application is operable with the processing device. The client application is provided to access the game application executed on a game server, which is interconnected to the processing device through a data interconnection.

According to an embodiment of the present invention, a remote control application is operable with the processing device, wherein the remote control application is adapted for remote control of toy device.

According to an embodiment of the present invention, a control application is provided, which is arranged for controlling the toy device. The control application enables to control a behavior of the toy device, especially a mechanical behavior, during playing in the real-world environment in accordance with toy specific characteristics. The control application controls preferably actuators of the toy device to exercise control over the behavior of the toy device during real-world playing.

According to an embodiment of the present invention, the processing device is arranged for detachable attachment to the toy device. The processing device has preferably a cover, which includes one or more projections or sockets cooperative with respective supports of the toy device.

### BRIEF DESCRIPTION OF THE DRAWINGS

For a better understanding of the present invention and to understand how the same may be brought into effect reference will now be made, by way of illustration only, to the accompanying drawings, in which:

FIG. 1 illustrates a schematic block diagram of components of a processing terminal embodied on the basis of a portable communication terminal according to an embodiment of the present invention;

FIG. 2a schematically illustrates a network environment and intercommunications of a plurality of processing terminals to enable multi-player gaming according to an embodiment of the present invention;

FIG. 2b schematically illustrates another network environment and intercommunications of a plurality of processing terminals to enable multi-player gaming according to an embodiment of the present invention;

FIG. 3a schematically illustrates a processing terminal and toy device environment according to an embodiment of the present invention; and

FIG. 3b illustrates a schematic block diagram of components of a toy device according to an embodiment of the present invention.

FIG. 3c shows another software and hardware implementation of the physical toy device in accordance with an embodiment of the present invention.

### DETAILED DESCRIPTION OF THE INVENTION

Throughout the description below, same and/or equal components will be referred by the same reference numerals.

Traditional real world gaming is conventionally based on toys including for instance cars, robots, pets, dolls, figures and the like. In the following description, the following definitions should be given. In virtual game play, especially role-playing games, an avatar should be understood as a manifestation of a character. The character contains the personality, history, abilities, attributes, experience, etc. of a game object that is controller by a player or a (pseudo, processor-controlled) artificial intelligence (AI) or both. One character may have several avatars or manifestations such as a druid who has for instance a human form and a bear form, respectively. When transferring these definitions into real-world game play, each avatar or manifestation has an associated figure representing the specific manifestations with the associated personality, history, abilities, attributes, experience, etc.

To generalize the wording of the present description on a virtual game play side the virtual game play objects, which are under control of the player, will be designated as playing pieces, whereas the corresponding real-world game play objects will be designated as toys for the sake of simplicity. Nevertheless, it should be understood that the aforementioned wording is not intended to limit the invention to any specific playing pieces and/or toys, which are solely descriptive terms on the basis of which the following embodiments are set forth.

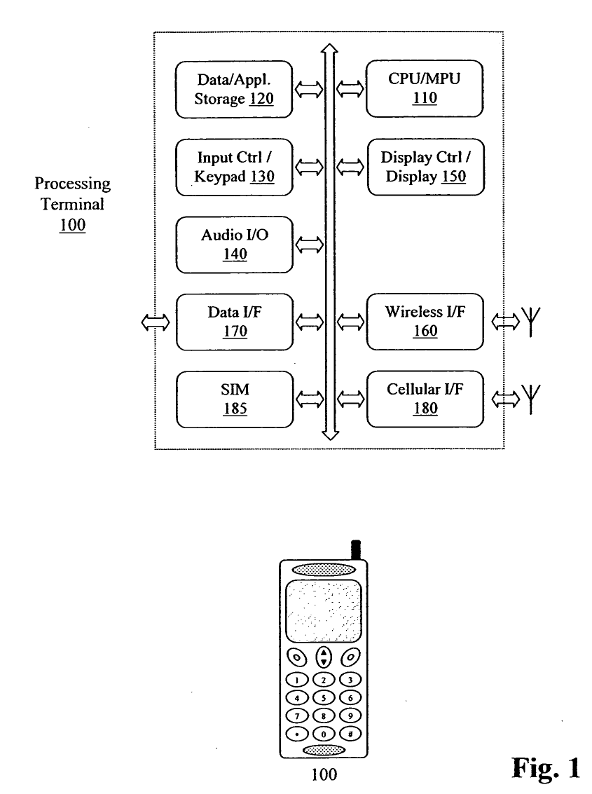

FIG. 1 shows a schematic block illustration of components of a portable communication terminal 100 in an exemplar form of a mobile or cellular telephone. The portable communication terminal 100 exemplarily represents any kind of processing terminal or device employable with the present invention. It should be understood that the present invention is neither limited to the illustrated portable communication terminal 100 nor to any other specific kind of processing terminal or device. As aforementioned, the illustrated portable communication terminal 100 is exemplarily carried out as cellular communication enabled portable user terminal. In particular, the portable communication terminal 100 is embodied as a processor-based or micro-controller based system comprising a central processing unit (CPU) and a mobile processing unit (MPU) 110, respectively, a data and application storage 120, cellular communication means including cellular radio frequency interface (I/F) 180 with radio frequency antenna (outlined) and subscriber identification module (SIM) 185, user interface input/output means including typically audio input/output (I/O) means 140 (typically microphone and loudspeaker), keys, keypad and/or keyboard with key input controller (Ctrl) 130 and a display with display controller (Ctrl) 150, a (local) wireless data interface (I/F) 160, and a general data interface (I/F) 170.

The operation of the portable communication terminal 100 is controlled by the central processing unit (CPU)/mobile processing unit (MPU) 110 typically on the basis of an operating system or basic controlling application, which controls the functions, features and functionality of the portable communication terminal 100 by offering their usage to the user thereof. The display and display controller (Ctrl) 150 are typically controlled by the processing unit (CPU/MPU) 110 and provides information for the user including especially a (graphical) user interface (UI) allowing the user to make use of the functions, features and functionality of the portable communication terminal 100. The keypad and keypad controller (Ctrl) 130 are provided to enable the user inputting information. The information input via the keypad is conventionally supplied by the keypad controller (Ctrl) to the processing unit (CPU/MPU) 110, which may be instructed and/or controlled in accordance with the input information. The audio input/output (I/O) means 140 includes at least a speaker for reproducing an audio signal and a microphone for recording an audio signal. The processing unit (CPU/MPU) 110 can control conversion of audio data to audio output signals and the conversion of audio input signals into audio data, where for instance the audio data have a suitable format for transmission and storing. The audio signal conversion of digital audio to audio signals and vice versa is conventionally supported by digital-to-analog and analog-to-digital circuitry e.g. implemented on the basis of a digital signal processor (DSP, not shown).

The keypad operable by the user for input comprises for instance alphanumeric keys and telephony specific keys such as known from ITU-T keypads, one or more soft keys having context specific input functionalities, a scroll-key (up/down and/or right/left and/or any combination thereof for moving a cursor in the display or browsing through the user interface (UI), a four-way button, an eight-way button, a joystick or/and a like controller. The keypad of the portable communication terminal 100 includes in a not limiting way one or more game specific input controllers and buttons as known from game console controllers and/or portable gaming consoles.

The portable communication terminal 100 according to a specific embodiment illustrated in FIG. 1 includes the cellular interface (I/F) 180 coupled to the radio frequency antenna (not shown) and is operable with the subscriber identification module (SIM) 185. The cellular interface (I/F) 180 is arranged as a cellular transceiver to receive signals from the cellular antenna, decodes the signals, demodulates them and also reduces them to the base band frequency. The cellular interface (I/F) 180 provides for an over-the-air interface, which serves in conjunction with the subscriber identification module (SIM) 185 for cellular communications with a corresponding base station (BS) of a radio access network (RAN) of a public land mobile network (PLMN).

The output of the cellular interface (I/F) 180 thus consists of a stream of data that may require further processing by the processing unit (CPU/MPU) 110. The cellular interface (I/F) 180 arranged as a cellular transceiver is also adapted to receive data from the processing unit (CPU/MPU) 110, which is to be transmitted via the over-the-air interface to the base station (BS) of the radio access network (RAN). Therefore, the cellular interface (I/F) 180 encodes, modulates and up converts the data embodying signals to the radio frequency, which is to be used for over-the-air transmissions. The antenna (not shown) of the portable communication terminal 100 then transmits the resulting radio frequency signals to the corresponding base station (BS) of the radio access network (RAN) of the public land mobile network (PLMN). The cellular interface (I/F) 180 preferably supports a 2nd generation digital cellular network such as GSM (Global System for Mobile Communications) which may be enabled for GPRS (General Packet Radio Service) and/or EDGE (Enhanced Data for GSM Evolution), UMTS (Universal Mobile Telecommunications System), and/or any similar or related standard for cellular telephony standard.

The wireless data interface (I/F) 160 is depicted exemplarily and should be understood as representing one or more wireless network interfaces, which may be provided in addition to or as an alternative of the above described cellular interface (I/F) 180 implemented in the exemplary portable communication terminal 100. A large number of wireless network communication standards are today available. For instance, the portable communication terminal 100 may include one or more wireless network interfaces operating in accordance with any IEEE 802.xx standard, Wi-Fi standard, any Bluetooth standard (1.0, 1.1, 1.2, 2.0+ER, LE), ZigBee (for wireless personal area networks (WPANs)), Infra-Red Data Access (IRDA), Wireless USB (Universal Serial Bus), RFID (radio frequency identification) communication, especially NFC (Near Field Communication) and/or any other currently available standards and/or any future wireless data communication standards such as UWB (Ultra-Wideband).

Moreover, the general data interface (I/F) 170 is depicted exemplarily and should be understood as representing one or more data interfaces including in particular network interfaces implemented in the exemplary portable communication terminal 100. Such a network interface may support wire-based networks such as Ethernet LAN (Local Area Network), PSTN (Public Switched Telephone Network), DSL (Digital Subscriber Line), and/or other current available and future standards. The general data interface (I/F) 170 may also represent any data interface including any proprietary serial/parallel interface, a universal serial bus (USB) interface, a Firewire interface (according to any IEEE 1394/1394a/1394b etc. standard), a memory bus interface including ATAPI (Advanced Technology Attachment Packet Interface) conform bus, a MMC (MultiMediaCard) interface, a SD (SecureData) card interface, Flash card interface and the like.

The components and modules illustrated in FIG. 1 may be integrated in the portable communication terminal 100 as separate, individual modules, or in any combination thereof. Preferably, one or more components and modules of the portable communication terminal 100 may be integrated with the processing unit (CPU/MPU) forming a system on a chip (SoC). Such system on a chip (SoC) integrates preferably all components of a computer system into a single chip. A SoC may contain digital, analog, mixed-signal, and also often radio-frequency functions. A typical application is in the area of embedded systems and portable systems, which are constricted especially to size and power consumption constraints.

Such a typical SoC consists of a number of integrated circuits that perform different tasks. These may include one or more components comprising microprocessor (CPU/MPU), memory (RAM: random access memory, ROM: read-only memory), one or more UARTs (universal asynchronous receiver-transmitter), one or more serial/parallel/network ports, DMA (direct memory access) controller chips, GPU (graphic processing unit), DSP (digital signal processor) etc. The recent improvements in semiconductor technology have allowed VLSI (Very-Large-Scale Integration) integrated circuits to grow in complexity, making it possible to integrate all components of a system in a single chip.

Typical applications operable with the portable communication terminal 100 comprises beneath the basic applications enabling the data and/or voice communication functionality a contact managing application, a calendar application, a multimedia player application, a WEB/WAP browsing application, and/or a messaging application supporting for instance Short Message Services (SMS), Multimedia Message Services (MMS), and/or email services. Modem portable communication terminals are programmable; i.e. such terminals implement programming interfaces and execution layers, which enable any user or programmer to create and install applications operable with the portable communication terminal 100. A today's well established device-independent programming language is JAVA, which is available in a specific version adapted to the functionalities and requirements of mobile device designate as JAVA Micro Edition (ME). For enabling execution of application programs created on the basis of JAVA ME the portable communication terminal 100 implements a JAVA MIDP (Mobile Information Device Profile), which defines an interface between a JAVA ME application program, also known as a JAVA MIDlet, and the portable communication terminal 100. The JAVA MIDP (Mobile Information Device Profile) provides an execution environment with a virtual JAVA engine arranged to execute the JAVA MIDlets. However, it should be understood that the present invention is not limited to JAVA ME programming language and JAVA MIDlets; other programming languages especially proprietary programming languages are applicable with the present invention.

With reference to the concept of the present invention, the portable communication terminal 100 comprises one or more gaming applications and/or one or more client applications for accessing networked gaming applications. Such gaming applications and/or client applications for accessing networked gaming applications can be arranged to employ the terminal's capability for data communications through one or the aforementioned interface. In accordance with one usage case of the present invention, a multi party game is addressed, which is arranged on an interconnected network.

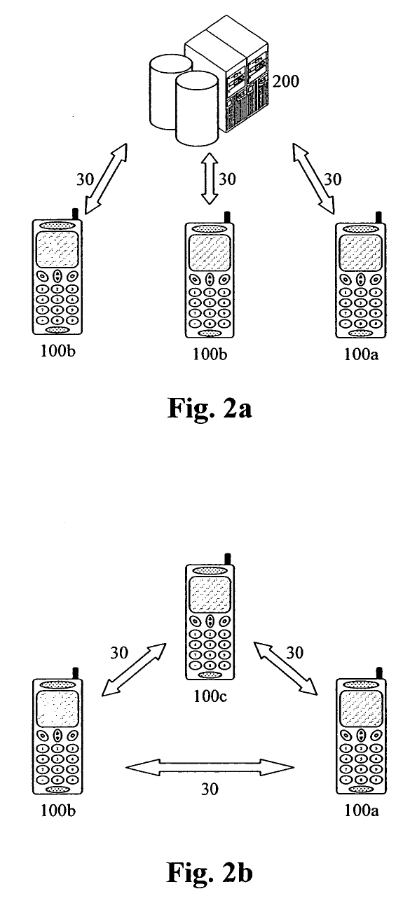

Connectivity of multiple portable communication terminals 100 for multi-player gaming is possible using a number of networking structures and/or protocols. As described herein generally and as shown in FIGS. 2a and 2b; primarily these connection schemes may include/involve application level protocols, such as a game protocol. Although there may be others than described here, different ways to establish connectivity may easily be available using substantially conventional wireless phone technologies. Briefly, these include for instance: a star topology; an ad hoc network; a limited ad hoc network; very simple radio frequency (RF) and/or Bluetooth (BT) connectivities, inter alia.

Although these will be described in further detail below, these connectivity or networking schemes may generally have a basic peer-to-peer and/or client/server structure, although a distributed server structure is another alternative. Note, in most cases, peer-to-peer will be prevalent, and a peer-to-peer application connected in an ad-hoc network is presently preferred. The first example for connectivity described here is a star topology with one acting server, and one or more portable communication terminals 100 communicatively connected to the server. Although a client/server network with a star topology is a networking arrangement known well in the art, a simple form thereof is set forth in FIG. 2a which shows a conventional star topology as may be used in an electronic multi-player game in an online-type of gaming environment. The star topology can include a number of interfaceable communication terminals 100a, 100b, 100c, and a central gaming server 200. These terminals 100a, 100b, 100c can be game enabled phones being connected via telephone, Bluetooth or short range radio to a central game server device 200. Though not shown in FIG. 2a, each mobile terminal 100a, 100b, and/or 100c may be communicatively connected to one or multiple toys. Also or alternatively, one or many mobile terminals 100a, 100b, and/or 100c can be communicatively connected to each toy (such toy connections are described further below). The intercommunications or data exchange(s) between the phones and the server (and thus also between the phones) are identified generally in FIG. 2a, as well as in the FIG. 2b using the general reference numeral 30. The interfacing terminals 100a, 100b, 100c could alternatively be computers and the communication lines 30 could then be via hardwire connections. Also, the intercommunications, whether via phone or computer may be via the internet network, and then the game server 200 is a centralized internet game server. As shown here, the interface terminals 100a, 100b, 100c are the game controllers of a video game. The star topology can provide a single simulation running in one place and the interface devices exchange just the moves of the players or other player specific data and not running the simulation itself. The star topology is often distinguished by a single processor running a single game or simulation program. The star topology may thus correspond to a hierarchical structure, wherein the server is the master and the interface devices are clients or slaves.

The actual game logic and an intelligent component may be located in the server 200 to control the game flow and ensure the data exchange 30 between different game partners 100a, 100b, and 100c. The server 200 may also control the availability of the participants and the handshaking procedure, when a new gaming partner joins or leaves the game as well as the status of connection of the clients (mobile gaming users). The server 200 may also take over the roles of gaming partners 100a, 100b, 100c in different situations, as for example, when one of the game partners leaves during a game. For this purpose an instance of an artificial intelligence (AI) engine of the server 200 can be present and activated automatically. This engine can then play against other game partners 100a, 100b, and/or 100c so that they may not be unnecessarily interrupted by the player who has left the game. Note also in many gaming applications, with this sort of networking organization, as is also true for other sorts, see below, it may be that the role of the server may be handed-off to one or more of the mobile communications terminals 100a, 100b, and/or 100c. Thus, in many cases, it may be possible for the server 200 to leave the game, either accidentally or on purpose, leaving control of the game to the mobile communications terminals. Such a server 200 may operate a complex game engine such as known from Massively Multiplayer Online Role-20 Playing Game (MMORPG) implementations enabling game play of thousands of simultaneous players.

Thus, shown in FIG. 2b is a generalized representation of one or more other perhaps more preferable usage scenarios, depending upon the computing power and/or memory of the terminals(s) 1 (e.g., 100a, 100b, and/or 100c) being used. Such networking schemes deal with multi party games either initiated or otherwise maintained (see above) by one (or more) mobile gaming partner(s) using a wireless communication terminal/server 100a/200 for game data exchange purposes. The wireless interconnection(s) 30 could be either one or more of an ad-hoc network, a limited ad-hoc network or either of a simple RF (radio frequency) interconnection or a BT (Bluetooth) connectivity, or a combination of one or more of the above. Note, as shown in FIG. 2b, all of the terminals 100a, 100b, and 100c are directly connected together in an interwoven or peer-to-peer fashion; thus, the terminal connections may be via telephone or short range radio, or Bluetooth, GPRS (general packet radio service), UMTS (Universal Mobile Telephone Standard), Wireless LAN (Local Area Network), Infra-Red (IR) and/or any other communication technology, preferably wireless.

Note the toy connectivity is described further below.

No matter which connectivity means is used for such a gaming party, one of the game partners may then act as a server and control the data exchange between different partners. The gaming terminal acting as server 100a/200 for such a game (as shown in FIG. 2b, e.g.), may thus play the same role as the network based (centralized) server 200, described in the above paragraphs. It may be noted that any of the terminals 100a, 100b, 100c may be the master/server, and also that there may be changes in roles of game server and clients (e.g., changing or handing-off the server role from one phone to another); procedures therefore being available and described in other publications thus not being described further here. FIG. 2b thus shows a conventional interwoven and/or peer-to-peer topology of an electronic multi-player game, as for example, with a number of game-enabled terminals 100a, 100b, and 100c. In difference to the star topology of FIG. 2a, the interwoven structure may be distinguished by either a single server or a distributed game program exchanging the moves between the single interface devices. Mixtures of both topologies are also possible, wherein a star topology is extended by star topology sub sections (“Snowflake” structures) or interwoven topology subsections. Alternatively, the interwoven topologies can comprise small star topology sub sections.

The basic concept of the present invention is a game environment or playful environment, which enables the player both to play the game on the basis of a virtual gaming environment and to play in a (physical) real-world environment. One or more game characters (game objects, game pieces, or virtual avatars) in the virtual gaming environment have corresponding toys, toy devices, toy-like items etc. in the physical real-world environment (especially physical avatars designated as toy devices). In accordance with the present invention, the game can be played within the virtual gaming environment established by the game application, where the player can take advantages of the virtuality of the gaming environment, and the game can also take place (can also be played) within the real-world by the means of physical toys or toy devices without using the game application at all. In the latter case, the one or more game characters (game objects or virtual avatar) of the virtual gaming environment are preferably replaced for physical playing by the one or more toys or toy devices. Consequently, the flow (or progress) of the game is separable into a flow (or progress) of the game in the virtual gaming environment (i.e. virtual playing) and a flow (or progress) of the playing in the physical world (i.e. real-world or physical playing). In principle, the basic concept may be distinguished into three general cases incorporated. The first case allows transfer of a state of the game from the virtual environment to the physical environment. In the (physical) real-world environment, the player however just plays with its toy device and the playing in the real-world environment does not affect the state of the game in the virtual gaming environment. The second case allows transfer of a state of the game from the physical playing to the virtual game and its virtual gaming environment. However, the playing of the virtual game does not affect the state of the game. The third case combines the two aforementioned cases. Playing of the virtual game affects the physical playing as well as the physical playing affects the virtual game. Though, the flow (or progress) of the game, although separated, is interconnectable to enable a uniform flow (or progress) of the overall game. This means, advances in the virtual game, which are for instance obtainable by the player in accordance with goals and/or rules of the virtual game, can affect the playing in the real-world environment. Vice versa, advances in the real-world environment, which are for instance obtainable in a more playful than game-like physical play, can affect the playing in the virtual game. Moreover, a development of the aforementioned inventive concept may encourage or invite the player of the game to play (predetermined) parts of the flow of the game within one of the virtual gaming environment or real-world environment for progressing in the overall game.

It should be noted that manual handling of the player with the toy, toy device, or toy like item may be the main aspect of the playing in the real-world environment. In contrast thereto, the playing of the virtual game in the virtual game environment may be determined by gameplay, game rules, and/or game stories as known from computer games, video games, video console game, and the like.

In accordance with an embodiment of the present invention, the implementation of the aforementioned basic inventive concept comprises substantially two parts; i.e. a software game application enabling the virtual game (conventionally the game application and/or the client application for accessing the game application), and, for enabling real-world playing, hardware and software implementation for the (physical) real-world playing in the real-world environment. The hardware and software implementation for the (physical) real-world playing should be designated as toy, toy device, or toy like item without limiting the invention thereto.

As aforementioned, the software game application enabling the virtual game can even be a simple Java applet (MIDlet) that runs in a mobile processing environment such as the portable communication terminal 100 or a complex game engine that supports playing of thousands simultaneous players e.g. on the basis of a Massively Multiplayer Online Role-Playing Game (MMORPG), which is preferably server-based. A main requirement is that the software game application of the virtual game has to be arranged for communication with the one or more (physical) real-world toy devices. Such a communication can be performed either on the basis of a direct peer-to-peer connection between the terminal running the software game application and the toy device or by the use of a game server (client/server architecture), where the communication is performed via one or more switching and/or routing network devices.

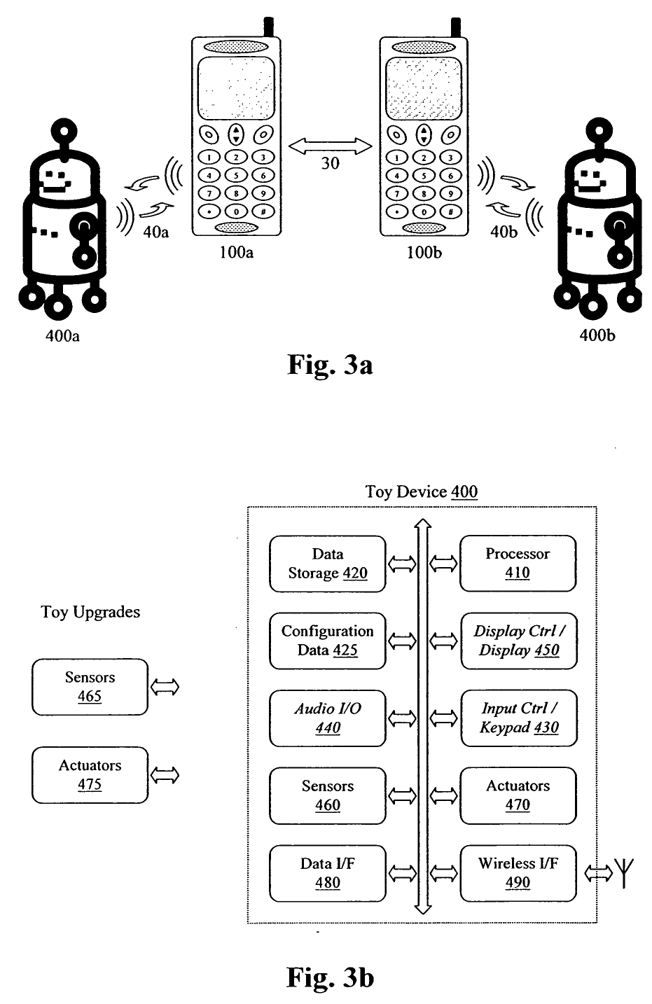

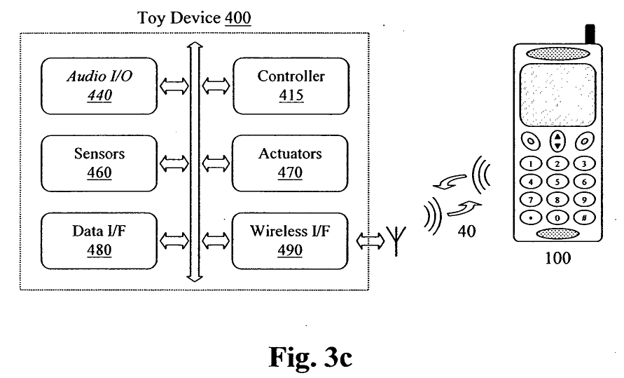

Referring now to FIG. 3a, an exemplary network gaming environment including portable communication terminals 100a and 100b and toy devices 400a and 400b associated with the respective portable communication terminal 100a and 100b is illustrated, respectively. Note that the illustrative network gaming environment of FIG. 3a is not limiting. This network gaming environment is based on the network environment described in more detail with reference to FIGS. 2a and 2b. As aforementioned, the network gaming environment may correspond to the star topology illustrated in FIG. 2a, the peer-to-peer topology illustrated in FIG. 2b or any combination thereof. Moreover, it should be noted that the present invention is also applicable with a single player environment comprising at least a portable processing terminal, by the means of which a virtual computer game can be played eventually through a link to a game server, and a toy device. Details about the network gaming environment are out of the scope of the present invention.

For the way of illustration, the communication terminals 100a and 100b are coupled through interconnection 30 for preferably wireless communications. Further, the toy device 400a associated with the communication terminal 100a is interconnected through an interconnection 40a, for instance by the means of any data communication technology, preferably a wireless interconnection, for bi-directional data communications. In analogy, the toy device 400b associated with the communication terminal 100b is interconnected through an interconnection 40b, for instance by the means of any data communication technology, preferably a wireless interconnection, for bi-directional data communication. It should be noted that although the toy devices 400a and 400b are shown as toy robots here, they may be made of many alternative device types and device appearances; the example type and appearance shown in FIG. 3a is not limiting.

With reference to FIG. 3b, a software and hardware implementation of the physical toy device 400 in accordance with an embodiment of the present invention is illustrated. The exemplary toy device 400 comprises essentially a (micro-) controller or (micro-) processor 410, one or more sensors 460, and one or more actuators 470.

The one or more actuators 470 of the toy device 400 may be provided to enable movement of the toy device 400 within the real-world space, e.g. one or more electric motors driving one or more wheels or one or more axles provided with one or more wheels, and movement of elements, attachment parts, arms, and the like of the toy device 400 relative thereto. More generally, such actuators 470 comprise, but not limiting thereto, electric motors allowing for translative, rotative, and/or pivoting movement of the toy device 400 relative in space and/or parts thereof relative to the toy device 400 itself, electric magnets, electric valves for driving pneumatics and the like.

The one or more sensors 460 of the toy device 400 are arranged to detect toy device specific sensor information and real-world specific sensor information. Such sensors may include, but not limited thereto, distance sensors (for detecting distances to one or more real-world objects relative to the toy device), velocity sensors, acceleration sensors, position sensors (for sensing a (time-dependent) position and/or course relative to any real-world point of reference), optical sensors (e.g. for sensing luminosity, intensity, color, and the like), audio sensors (for sensing and/or recording audio signals; microphones), image/video sensors (such as a digital image detector, video camera and the like; preferably on the basis of a charge coupled device), contact sensors, goniometers, and the like. Moreover, such sensors also may include, but not limited thereto, sensors which are configured to sense a user actuation, a user manipulation, and/or a user operation at or with the toy device 400, and/or a movement of the toy device 400 caused by handling of the toy device 400 by the player (user). It should be understood that the manipulation of the toy device 400 of the player may be preferably obtained by manual manipulation and/or remote manipulation controllable by the player. The sensor information obtained and detected is registered to allow reconstruction of the flow of the play of the player with the toy device 400.

The sensor information include in particular a course covered by the toy device 400, i.e. a trajectory in space, and log actuations, operations, etc by the player on the toy device 100 or parts thereof. This means, the sensor information may comprise information about physical contacts or touches of the player at the toy device 400, movements of legs, arms and/or other extremities/extension parts of the toy device 400, and pushing of the toy device 400.

Note that one or more sensors 460 may be implemented in the toy device 400 or may be provided in a spatial separated arrangement with the toy device 400.

Moreover, the components of the toy device 400 may be modified, altered, replaced, and/or reconstructed. The toy device 400 is preferably assembled of several components on the basis of a construction kit. This means that the player/user of the toy device 400 can determine the appearance and shape of the toy device 400 but also implement new sensors 465 (including additional sensors and/or new types of sensors) and new actuators 475 (including additional actuators and/or new types of actuators).

As aforementioned, the toy device 400 is able to communicate at least with the virtual game application e.g. though the interconnection 40 and the portable communication terminal 100. Correspondingly, the toy device 400 implements one or more data interfaces 480 and/or wireless data interfaces 490.

The wireless data interface (I/F) 480 is depicted exemplarily and should be understood as representing one or more wireless network interfaces. A large number of wireless network communication standards are available today. For instance, the toy device 400 may include one or more wireless network interfaces operating in accordance with any IEEE 802.xx standard, Wi-Fi standard, any Bluetooth standard (1.0, 1.1, 1.2, 2.0+ER, LE), ZigBee (for wireless personal area networks (WPANs)), Infra-Red Data Access (IRDA), Wireless USB (Universal Serial Bus), RFID (radio frequency identification) communication technology (e.g. RFID reader interface; a Near Field Communication (NFC) standard) and/or any other currently available standards and/or any future wireless data communication standards such as UWB (Ultra-Wideband). Furthermore, any proprietary radio frequency interface enabling uni- or bi-directional data communication may also be implemented.

Moreover, the data interface (I/F) 470 is depicted exemplarily and should be understood as representing one or more data interfaces including in particular network interfaces implemented in the exemplary toy device 400. Such a network interface may support wire-based networks such as Ethernet LAN (Local Area Network), PSTN (Public Switched Telephone Network), DSL (Digital Subscriber Line), and/or other current available and future standards. The data interface (I/F) 470 may also represent any data interface including any proprietary serial/parallel interface, a universal serial bus (USB) interface, a Firewire interface (according to any IEEE 1394/1394a/1394b etc. standard), a memory bus interface including ATAPI (Advanced Technology Attachment Packet Interface) conform bus, a MMC (MultiMediaCard) interface, a SD (SecureData) card interface, Flash card interface and the like.

It should be noted that the capability for data communication may also be employed for intercommunication with one or more other toy devices or accessory devices (for details see below).

Audio input/output (I/O) means 440 may be implemented in the toy device 400 for instance by the means of a speaker and a microphone to enable audio recording and/or audio reproduction. The audio input/output means 400 are preferably implemented on the basis of a digital signal processor (DSP), which supports digital-to-analog and/or analog-to-digital signal conversion, preferably audio signal conversion. In general, an audio input functionality may be employed to enable voice/speech control of the toy device 400 on the basis of a speech recognition system, which is capable to receive spoken commands and convert such spoken commands into corresponding instructions for controlling functions of the toy device 400 such as moving, rotating, and pivoting of the toy device 400 and/or parts thereof. Moreover, the interconnection between the toy device 400 and the associated portable communication terminal 100 can be employed to enable voice/speech control of the functions of the portable communication terminal 100. In connection with an audio output functionality messages received by the portable communication terminal 100 can be accessed via a spoken command and are read by the toy device 400 with the help of a synthesizer converting text messages into spoken messages.

A display controller (Ctrl) and display 450 may be implemented in the toy device 400 to enable display of operation information, notifications, messages, and the like. Further, an input controller (Ctrl) and keypad 430 may be provided to enable the user/player of the toy device 400 for user input.

A data storage 420 is provided, which is arranged to store gaming related data received from the virtual game software (which is preferably operated by the portable communication device 100 and the game server 200, respectively) and sensor information obtained by the sensors/detectors 460 implemented, fitted in the toy device 460 or arranged therewith.

In addition, configuration data 425 enable to define the functionality and/or the capabilities of the toy device 400. The configuration data 425 may comprise configuration data relating to functions of the toy device 400. In accordance with such configuration data one or more functions of the toy device 400 may be activated or deactivated, or the functions may be limited within defined constraints (or limitations), and the like. For example, the maximum speed of (translation, rotation, pivoting) movement of the toy device 400 and/or parts thereof (an arm, a head, e.g.) may be configured in accordance with configuration data. The moveablilty of parts of the toy device 400 may be enabled, disabled, or configured in accordance with the configuration data. In general, the configuration data 425 enables to configure and define operation characteristics of the actuators 470 and hence the operation characteristics of the toy device 400 or parts thereof driven by the actuators 470. Likewise, the configuration data 425 enables to configure and define the operation characteristics of the sensors 460 implemented in the toy device 400.

With reference to FIG. 3c, another software and hardware implementation of the physical toy device 400 in accordance with an embodiment of the present invention is illustrated. The implementation of the physical toy device 400 in accordance with an embodiment of the present invention described above with reference to FIG. 3b represents a complex and sophisticated realization of the physical toy device 400. A more simplified implementation is illustrated in FIG. 3c.

The physical toy device 400 of FIG. 3c in accordance with an embodiment of the present invention comprises only essential components to be implemented therein. The toy device comprises a (micro-) controller 415, one or more sensors 460, one or more actuators 470 and at least one data interface (I/F); i.e. a data interface (I/F) 480 or a wireless data interface 490. For details about these components, reference should be given to the description above.

The controller 415 is arranged to provide basic control of the implemented components, especially, the one or more sensors 460, the one or more actuators 470 and the at least one data interface (I/F) 480 or 490. Advantages are taken from a processing terminal interconnected through the interconnection 40 to the toy device 400. The processing terminal may be the portable communication terminal 100 as depicted or may be any other processing terminal such a PC, notebook, and the like. The interconnection 40 is operated via corresponding data interfaces (I/F) of the toy device 400 and the connected portable communication terminal 100. The processing and storage capacity of the portable communication terminal 100 is used to provide control logics (realized in hardware and/or software), sensing logics (realized in hardware and/or software), and data storing for the toy device related data and/or game related data.

The control logics are arranged to control the actuators of the toy devices. This means that the controller for instance can be instructed to supply to an actuator a defined current, a defined voltage, a defined pulse sequence and the like. The control logics implemented in the portable communication device 100 is configured to instruct the controller correspondingly such that actuators 470 of the toy device operate in accordance with the control logics. The sensors and/or detectors 460 of the toy device supply their respective sensed values. The sensing logics receive the sensed values, evaluate the sensed values, and/or store the results of the evaluation to enable the interoperability between the game on the basis of the virtual game application and playing with the toy device in the real-world environment. The complexity of the sensing logics may depend on the type of the sensors employed. This means that the sensing logics may be arranged for storing the sensed values in a time and/or or event triggered manner or the sensing logics may operate more or less processing procedures to extract the desired sensor information from the sensed values. Such processing procedures can be performed on the basis of hardware and/or software and can be provided with the toy device or as software module comprised by the game application or interpose within the data communication of the sensor information between the toy device and the game application.

In particular, the portable communication device 100 may be detachably attached to the toy device 100. The portable communication device 100 provides its processing/storage capacity and/or input/output means (including especially the keypad, the display, the communication interfaces etc.) to enable the realization of a processor-controlled toy device 400. The capability of the portable communication device 100 to execute applications can be used to provide specific toy applications adapted to control the operation of the toy device 400. An application program interface (API) layer may be provided for interfacing between such a toy specific control application and the toy device 400 as well as the toy specific control application and the virtual game application. The API layer may also control the moving of data (audio and video stream, file transfer, and the like) to and from the toy device as well as to and from other processing device. Other API functionalities on the portable communication terminal may include accessing and controlling the toy device and the implementation of different applications. Such an API may also provide the connection logistics, as in providing a continuous observation of network connectivity and maintaining the connectivity, e.g., the disconnections may be automatically reconnected. The API may also provide an application interface between one or more portable communication terminals and third party accessories, toy devices and/or environment pieces.

In addition, it should be noted that the data interface (I/F), especially the wireless data interface (I/F) 490 of the toy device may be employed for data communications between one or more further toy devices 400a, 400b to enable improved interacting of the toy devices displaced within a coverage area of the wireless data interface (I/F).

In summary, the toy device 400 exemplarily illustrated in FIGS. 3a, 3b, and 3c in accordance with an embodiment of the present invention is distinguished by several main concepts.

Interoperability and Configurability

As aforementioned, the basic concept of the present invention is a game environment or playful environment, which enables the player both to play the game on the basis of a virtual gaming environment and play the game within a (physical) real-world environment. The virtual gaming environment comprises typically one or more game pieces, game characters, (virtual) game objects, or virtual avatars and the like. Such a game piece, game character, (virtual) game object, or virtual avatar is associated with a (physical) real-world counterpart, i.e. the toy device. The toy such as the toy device described above with reference to FIGS. 3a and 3b represents a physical representation of the virtual game object.

In accordance with the present invention, the game can take place within the virtual gaming environment established by the game application and the player is enabled to play within the real-world with the help of physical toys without using the game application. A player can play the virtual game application in the virtual gaming environment as provided by the application. During playing of the virtual game application the game objects the characteristics (attributes, properties, abilities, etc.) can be developed. This means that the player can achieve additional and new characteristics (attributes, properties, abilities, etc.) when a defined objective of the game story is achieved. The development of the game is stored by the virtual game application. The player can likewise play with the toy in the real-world environment such as traditionally done. The interoperability and configurability of the toy device according to an embodiment of the present invention enables transferring of the play of the game (i.e. characteristics thereof) from the virtual gaming environment to the real-word environment and vice versa. In general, the state of the game in the virtual gaming environment is modified on the basis of the playing in the real-world environment by the means of the toy device. Though, the flow of the game, although separated, is interconnected to enable a uniform flow of the overall game. This means in particular that information about the playing in the real-world environment (obtainable from registered sensor information) and/or characteristics (attributes, properties, abilities, etc.) of a toy device in the real-world is transferable to state of the virtual game and/or to characteristics (attributes, properties, abilities, etc.) of an associated virtual object in the virtual gaming environment and vice versa. This makes it possible to play and to advance in the virtual game application with the physical toy device without playing the virtual game application at all. And vice versa, when playing the virtual game application in virtual gaming environment, advances therein may result in advances of the toy device in the real world.

For instance, when the player interacts with a virtual avatar and a toy device of a game character, respectively, persistent changes in the state of the game character as well as the toy device are created. The virtual avatar characteristics, attributes, and abilities will change when the virtual avatar has used its characteristics, attributes, and abilities in virtual game in the virtual gaming environment or the player (user) has played with the associated toy device in the real-world environment. These alterations can be made visible with graphical user interface (GUI) changes in the virtual gaming environment. In the real world, the play practice of the toy device can be detected on the basis of different sensors and detectors that will sense the playing in the real world, for instance how many times the toy gun is fired or how many times the legs of toy dog are bended.

The interoperability and configurability as described above allow creating new complex game structures, where the players are invited, encouraged, or required to play defined sequences in the virtual gaming environment as well as in the real-world environment to develop the overall game in accordance with a game.

Nevertheless it should be noted that the playing with the toy device in the real-world environment is not necessarily required to be embedded within an overall game. The playing in the real-world may simply comprise any playing just as traditionally done with dolls or any other (physical) game figures and toys. The playing in the real-world is not necessarily embedded into a game story or game rules, whereas the virtual game, which is played in the virtual gaming environment, follows typically the concepts of video games.

Connectivity

In order to enable the aforementioned interoperability and configurability of both the game object and the corresponding toy device, configuration and game related data is exchanged between the virtual game application and the toy device. Preferably, the configuration and game related data is stored in a centralized manner to enable access (for reading and/or writing) by virtual game application and the toy device at any time, respectively. More preferably, the configuration and game related data is maintained at a central gaming server 200. The toy device is equipped with an adequate (bi-directional) data interface to retrieve and file the configuration and game related data required to transfer the characteristics (attributes, properties, abilities). The maintenance of the configuration and game related data by the means of a central gaming server 200 enables a player also to access this data such that the virtual game can be continued at any time and at any place preferably by the use of the portable communication device 100. An interconnection between the central game server 200 and the toy device can be established by the means of a portable communication device 100 detachably mounted to the toy device 400 and switching/routing therebetween.

Without limiting the present application thereto, reference should be given to the aforementioned three principle cases. In the first case, the connectivity between the virtual game application and the toy device allows transfer of a state of the game from the virtual gaming environment to the physical environment. The transferred game state is applied to configure the toy device accordingly. Refer to the aforementioned embodiments concerning the configurability of the toy device. In the (physical) real-world environment, the player however just plays with its toy device and the playing in the real-world environment is not transferred to the virtual game application such that the playing in the real-world environment has no effect on the state of the game in the virtual gaming environment.

In the second case, the connectivity between the virtual game application and the toy device allows transfer of a state of the game from the physical playing to the virtual game to the game application enabling playing in the virtual gaming environment. This means that the state of the game is determined on the basis of the playing registered on the basis of the sensor information obtained during real-world playing. The registered playing, i.e. the sensor information, is transferred with the help of the connectivity described above to the game application, where the registered real-world playing is utilized to affect the state of the game in the virtual gaming environment. However, the playing of the virtual game does not necessarily affect the state of the game.

The third case merges the two aforementioned cases. This means, the real-world playing of the player in the real-world environment with its toy device as well as the playing of the player in the virtual gaming environment by the means of the game application produces an effect on the state of the game. The registered playing, i.e. the sensor information, is transferred from the toy device (and its sensor information storage, respectively) to the game application, where the registered real-world playing is utilized to adjust the state of the game in the virtual gaming environment. Vice versa, the state of the game in the virtual gaming environment is transferred from the game application (and the storage, respectively, provided for storing the state of the game including for instance configuration and/or game related data) to the toy device (and its data storage, respectively). The transferred game state is applied to configure the toy device accordingly.

Modularity

The toy device may be constructed in the form of a mainframe object, which allows connection of several physical extensions to be connected into the mainframe object. These extensions could for instance be sold in upgrade kits or they could be constructed with the help of specific tutorials, which might be published by a game engine. These tutorials comprise assembly instructions for such extensions, which have been achieved by the player in accordance with the progress/development in the game. Such extensions can be employed to reflect and transfer the development of the characteristics (attributes, properties, abilities, etc.) of the virtual game object into the real-world environment. Moreover, extensions of the toy device can the basis for developing the game object in the virtual gaming environment. Each extension attached to the toy device results in a modification (development) of its characteristics (attributes, properties, abilities), which are transferred into the virtual gaming environment for a development of the corresponding virtual object.

Moreover, the assemblage of the toy device is based on a construction kit such that the player is free in constructing the toy device and the characteristics thereof. The modularity, which is given to the toy device being assembled by the means of a construction kit, enables the player to realize various appearances of the real world toy device associated with different appearances (virtual avatars) of the corresponding virtual game object. The characteristics (attributes, properties, abilities, etc.) of an assembled toy device may be detected for instance by the means of sensors and the detected characteristics (attributes, properties, abilities, etc.) are reported to the virtual game application in order to define the characteristics (attributes, properties, abilities, etc.) of the corresponding virtual game object in accordance with the detected ones from the (physical) toy device. Moreover, the toy device may be re-assembled, modified, and/or new add-ons can be attached thereto. Each modification due to re-assemblage, modifications, or upgrading can be reported to the virtual game application by the means of the game data and configuration data exchanged between the toy device and the virtual game application. The re-assemblage, modifications, or upgrading (by the means of add-on components and/or extension components) may be (automatically) sensed by one or more sensors implemented.

The toy device according to an embodiment of the present invention may include toy elements such as toy elements constructable from the Robotics Invention System from LEGO MIND-STORMS construction sets or assembly kits, a toy product that can be used to create various toy types, vehicles, cars, robots and the like which conventionally can be programmed by means of a computer to perform certain actions, mobile and otherwise. For details, reference should be given to http://mindstorms.lego.com/ incorporated by reference herewith. Note that the present invention is not limited to any manufacturer-specific construction sets or assembly kits. The aforementioned system should be understood as illustrative of a general class of construction sets or assembly kits. Note, in addition to the basic bricks, such systems offer a microcomputer, an infrared and a radio transmitter, sensors including for instance a touch sensor, a light sensor, a rotation sensor, a camera with an USB connection, and a built-in microphone, audio input/output components including a speaker and a microphone, actuators including especially electric motors, and batteries. Thus, the present invention is usable with toys which may either be pre-constructed or which may be constructed by the player/user in any of various shapes and/or types from construction sets which may include one or more block components; the block components each having a main block section having a head portion forming a protrusion or stud portion projecting out of the main block section, and a second end portion of a base including an indentation or coupling socket recessed into the second face of the main block section, wherein the indentation is complimentary in shape with respect to the protrusion. Then, the user can use such blocks to build robotic or automobile toy products.

Typically, such assembly kits enable the building of either simple toys or rather complex mechanical structures and include various electronic components to control, for example, remote-controlled vehicles (for instance LEGO Racers) and PC-controlled robots (for instance Lego's Robotics Invention System, and Spybotics), inter alia. More specific application of the mobile technologies described hereinabove and their usage cases with such toys could include the following, inter alia:
Bluetooth: Use of Bluetooth for the bi-directional data transmission between a toy device and a portable communication device.
Movement and rotation sensors: Movement and rotation sensors may be used to sense the relative movement of the toy within the real-world space in order to record a trajectory of the toy, for example, a car driving on a predefined course, or a robot having been shot.
A gesture recognition engine, as may be available from the Nokia Company could be used to control, for example, a robot's hand movements, etc.
Vibras: Vibrations integrated into the toy can be employed to create a vibrational effect in the toy.
Integrated Hands-Free (IHF) speaker and microphone: Recording of audio signal, which may be supplied to a speech recognition system; reproduction of speech and audio; and/or audio processing to create audio effects to simulate, for example, a car engine or to morph speech in/from a robot.
   Controllability

The toy device may be remotely controlled by the means of the portable communication terminal. The portable communication terminal 100 is operable by a user/player, as per the keypad inputs to send controlling commands (wirelessly or wire-based) to the toy device 100. In the case of the toy device being a robot (a car or a truck or a motorcycle or other type of automobile or like mobile machine, for example) paired with a portable communication terminal 100 as shown in FIG. 3a, e.g., driving the robot, after ensuring power on for both the robot and the portable communication terminal, may be through use of the buttons/keys of the portable communication terminal 100 or a joystick thereof, if available, to move the robot forward, backward, left or right, or any directional orientation therebetween (particularly if joystick or multidirectional button operated). Speed changes may also be effected by pressing keys/buttons dedicated for such purpose. Instead of using the alphanumeric keys for moving and selecting toy device, special game keys may, according to an embodiment of the invention, be integrated in the portable communication terminal 100. In some embodiments, the input and output controls, i.e., the I/O system may preferably be programmable.

Use Cases

An exemplary first use case according to an embodiment of the present invention addresses a virtual pet game. The game story requires the player/user to take care and train a virtual pet or monster. The player is enabled to play this virtual pet game in the aforementioned two gaming environments, i.e. the virtual gaming environment and the real-world environment. In the virtual gaming environment, e.g. a mobile game application, the player can, for instance, train and feed the virtual pet or monster. In the (physical) real-world environment, the game character, i.e. the virtual pet or monster, has a physical form, i.e. the toy device, for instance, in form of a LEGO robot. A training of the pet or monster can now be played by the means of the pet/monster toy device. The characteristics of the virtual pet or monster as well as the pet/monster toy device depend on the play of the player in the virtual gaming environment as well as the playing in the real-world environment. The virtual pet game is realized as a mobile game application, i.e. the player employs its portable communication device as electronic game console. The mobile game application can be executed by the portable communication device or alternatively, the portable communication device executes a game client application, which connects to a game sever running the actual game application. In the first case, the persistent state of the game character of the virtual pet and the pet toy is preferably maintained by the portable communication device. In the latter case, the game server is provided for maintaining the persistent state of the game character of the virtual pet and the pet toy. The interconnectivity between the mobile game application and the toy device can be achieved for instance by detachably mounting the portable communication device employed for mobile gaming on the toy device. In the (physical) real world environment, the player can make the toy device, for instance, to race, fight, play sounds, or dance.

An exemplary first use case according to an embodiment of the present invention addresses an (multi-player) adventure game application, where a player plays virtual game characters in a virtual gaming environment and the player has also a (physical) toy device for playing in the real-world environment. The adventure game application is preferably a mobile adventure game application carried out by the means of a portable communication terminal. In analogy to the aforementioned implementation, mobile adventure game application can be executed by the portable communication device or preferably, the portable communication device executes a game client application, which connects to a game sever running the actual adventure game application. The toy device is interconnected with the portable communication device, preferably by detachably attaching the portable communication device to the toy device. In case of a server residing application, the game client application is connected to the game server that hosts all game information including for instance also game information of several other players. The game server is used to maintain the game data. The game story provides for adventuring in the virtual game world and practising in the real world. For instance all fights and combats are decided on the basis of attribute base scores. Real time button pressing actions are not required. The attributes of the virtual game character depend on how well the player has made real world practises with the toy device associated with the virtual game character in the real world. For example, if the player wants to develop the shooting attributes of the virtual game character, the player has to use a dart gun of the toy device and has to successfully hit one or more targets. Such targets can be either constructed by the player or may be available as upgrades that will be sold separately. Constructed targets suit well with aforementioned Lego idea. The hits are detected by the sensors connected to the toy device. The player can also play with the toy device without having connectivity to the game application at all. The connectivity to the game application is required to transfer the recorded play with the toy device. Thereafter, the player can check the points that have been gathered during playing with the toy device. The player could be enabled selecting an adventure that he wants to play and use only the physical toy device. A mobile communication device or computer could provide the sounds and some additional effects. The advantage of this solution is that the player can easily take his toy with him where ever he goes, and interact with it when ever he wants.

As a summary, the present invention is directed enable interconnectivity between virtual game applications and physical toys for playing in real-world. The interconnectivity of both gaming types allows bringing together the specific advantages thereof. The user/player can play in both environments to progress in the game story.

The concept of the present invention is applicable with a single player game as well as a multi-player game, where several players are acting in a common virtual gaming environment and the players can also meet in real-world for playing with the help of their toy devices. The progress in the play in the virtual gaming environment as well as in the real-world environment affects the overall flow of the game.

Several different games can be implemented within this conceptual framework: miniature or toy car racing, robot wrestling or boxing or other interactive combat-type games, tank or other war machine battling, adventure games,) role games, etc. Note also that either each single player may have a respective single toy (for example: rally game, each player having its own car).

1. A method for using a toy device (400), comprising:
providing a game application to a player for playing a game in a virtual gaming environment comprising at least one game object controllable by the player;
providing the toy device to the player for playing in a real-world environment;
wherein the toy device has one or more sensors allowing to detect how the player interacts with the toy device;
by the means of the one or more sensors, registering sensor information detected in consequence to the player playing with the toy device in the real-world environment; and
transferring the sensor information to the game application to adjust a state of the game in the virtual gaming environment in accordance with the playing in the real-world environment.

2. The method according to claim 1,
wherein the game object has game specific characteristics, which are developable during playing,
wherein the toy device represents a real-world analog of the game object,
wherein the sensor information is transferred to the game application to adjust the game specific characteristics of the game object in accordance with the playing in the real-world environment.

3. The method according to claim 1, comprising:
inviting the player to perform at least a part of the game with the toy device in the real-world environment in order to progress in the game in the virtual gaming environment.

4. The method according to claim 1, comprising:
enabling the player playing in the real-world environment at any time, wherein the registered sensor information in consequence to the playing in the real-world environment is transferable to the game application at any time.

5. The method according to claim 1, wherein
the playing in the real-world environment is operative within rules of the game.

6. The method according to claim 1, wherein
the toy device represents a manifestation of the game object.

7. The method according to claim 1 comprising:
providing accessory to the toy device, wherein the accessory improves toy specific characteristics of the toy device, wherein the toy specific characteristics affect the playing with the toy device in the real-world environment; and
transferring the characteristics of the toy device to the game application to adjust the game specific characteristics of the game object in accordance with the toy specific characteristics.

8. The method according to claim 1, wherein
the toy device is user-constructable from a set of interlocking elements, wherein toy specific characteristics of the toy device are based on a resulting user construction thereof;
the method comprising:
transferring the characteristics of the toy device to the game application to adjust game specific characteristics of the game object in accordance with the toy specific characteristics.

9. The method according to claim 1, comprising:
transferring the game specific characteristics resulting from the playing in the virtual gaming environment to the toy device; and
adjusting toy specific characteristics in accordance with the game specific characteristics.

10. The method according to claim 1, wherein
the toy device comprises a controlling logic, which controls a behavior of the toy device during playing in accordance with toy specific characteristics.

11. The method according to claim 1, wherein
the game application is hosted on a game server;
the method comprising:
providing a client application for accessing a game engine executed on the game server to play the game in the virtual gaming environment.

12. The method according to claim 1, wherein
the game server maintains game related data including game specific characteristics of the game object.

13. The method according to claim 1, comprising:
remotely controlling the toy device by means of a portable processing device acting as remote controller; in particular a portable communication device provided with remote control software.

14. The method according to claim 1, comprising:
establishing an interconnection between the toy device and the game application through a processing device; in particular a portable communication terminal.

15. The method according to claim 1, comprising:
operating the toy device by means of a processing device detachably attached to the toy device, in particular a portable communication device having a cover including one or more projections or sockets cooperative with respective supports of the toy device.

16. The method according to claim 15, comprising:
registering the sensor information with help from the processing device.

17. The method according to claim 1, wherein
the toy device comprises a data communication interface communicative with a processing device, in particular a portable communication device.

18. A toy device (400) operative in a game, comprising:
one or more sensors allowing to detect how a player interacts with the toy device in a real-world environment;
a data interface arranged for transferring sensor information to a game application;
wherein the game application is provided to the player for playing in a virtual gaming environment comprising at least one game object controllable by the player; and
the toy device is provided to the player for playing in a real-world environment;
wherein the sensor information enables to adjust a state of the game in the virtual gaming environment in accordance with the playing in the real-world environment.

19. The toy device according to claim 18,
wherein the game object has game specific characteristics, which are developable during playing,
wherein the toy device represents a real-world analog of the game object,
wherein the sensor information is transferred to the game application to adjust the game specific characteristics of the game object in accordance with the playing in the real-world environment.

20. The toy device according to claim 18,
wherein the player is invited to perform at least a part of the game with the toy device in the real-world environment in order to progress in the game in the virtual gaming environment.

21. The toy device according to claim 18,
wherein the player is enabled for playing in the real-world environment at any time, wherein registered sensor information in consequence to the playing in the real-world environment is transferable to the game application at any time.

22. The toy device according to claim 18,
wherein the playing in the real-world environment is operative within rules of the game.

23. The toy device according to claim 18,
wherein the toy device represents a manifestation of the game object.

24. The toy device according to claim 18, comprising:
accessory provided for the toy device, wherein the accessory improves toy specific characteristics of the toy device, wherein the toy specific characteristics affect the playing with the toy device in the real-world environment;
wherein the characteristics of the toy device are transferred to the game application to adjust game specific characteristics of the game object in accordance with the toy specific characteristics.

25. The toy device according to claim 18,
wherein the toy device is user-constructable from a set of interlocking elements, wherein toy specific characteristics of the toy device are based on a resulting user construction thereof, and
wherein the characteristics of the toy device are transferred to the game application to adjust game specific characteristics of the game object in accordance with the toy specific characteristics.

26. The toy device according to claim 18, wherein
game specific characteristics resulting from the playing in the virtual gaming environment are transferred to the toy device;
wherein toy specific characteristics are adjusting in accordance with the game specific characteristics.

27. The toy device according to claim 18,
wherein the toy device comprises a controlling logic, which controls a behavior of the toy device during playing in accordance with toy specific characteristics.

28. The toy device according to claim 18,
wherein the game application is hosted on a game server; and
a client application is provided for accessing a game engine executed on the game server to play the game in the virtual gaming environment.

29. The toy device according to claim 18,
wherein the game server maintains game related data including game specific characteristics of the game object.

30. The toy device according to claim 18, comprising:
the toy device arranged for remote control by means of a portable processing device; in particular a portable communication device provided with remote control software.

31. The toy device according to claim 18, comprising:
a data interconnection established between the toy device and the game application through a processing device; in particular a portable communication terminal.

32. The toy device according to claim 18,
wherein the toy device is operable by means of a processing device detachably attached to the toy device; in particular a portable communication device having a cover including one or more projections or sockets cooperative with respective supports of the toy device.

33. The toy device according to claim 32,
wherein sensor information is registered with help from the processing device.

34. The toy device according to claim 18, wherein
the toy device comprises a data communication interface communicative with a processing device, in particular a portable communication device.

35. A processing device (100) arranged for operatively coupling with a toy device,
wherein the toy device comprises one or more sensors, which are arranged for detecting how a player plays with the toy device and for providing sensor information in consequence to how the player plays with the toy device in a real-world environment
the processing device comprises a data interface arranged for communication with the toy device to transfer the sensor information provided by the toy device to a game application;
wherein the game application is for use by the player playing in a virtual gaming environment comprising at least one game object controllable by the player; and
the toy device is for use by the player playing in the real-world environment;
wherein the sensor information enables to adjust a state of the game application in the virtual gaming environment in accordance with the playing in the real-world environment.

36. The toy device according to claim 35,
wherein the game object has game specific characteristics, which are developable during playing,
wherein the toy device represents a real-world analog of the game object,
wherein the sensor information is transferred to the game application to adjust the game specific characteristics of the game object in accordance with the playing in the real-world environment.

37. The processing device according to claim 35, wherein the processing device is one out of a group comprising a portable communication terminal, a personal computer, and a notebook computer.

38. The processing device according to claim 35, comprising:
the game application executed thereon.

39. The processing device according to claim 35, comprising:
a client application adapted to access the game application executed on a game server interconnected to the processing device through a data interconnection.

40. The processing device according to claim 35, comprising:
a remote control application arranged for remote control of the toy device.

41. The processing device according to claim 35, comprising:
a control application arranged for controlling the toy device, wherein the control application enables to control a behavior of the toy device during playing in accordance with toy specific characteristics.

42. The processing device according to claim 35,
wherein the processing device is arranged for detachable attachment to the toy device;
wherein the processing device has in particular a cover including one or more projections or sockets cooperative with respective supports of the toy device.
